(19) United States
(12) Patent Application Publication
(10) Pub. No.: US 2008/0252233 A1
(43) Pub. Date: Oct. 16, 2008

(54) Universal Line Voltage Dimming Method and System

(75) Inventor: Mingliang Wu, Schaumburg, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/914,139

(22) PCT Filed: May 9, 2006
(86) PCT No.: PCT/IB06/51459

§ 371 Date: Jun. 2, 2008

Related U.S. Application Data
(60) Provisional application No. 60/679,352, filed on May 10, 2005.

(51) Int. Cl. H05B 41/36

(52) U.S. Cl. 315/291

(57) ABSTRACT

A universal line voltage dimming method and system, with a control circuit for an electronic ballast including an on-time converter (50) generating an on-time signal (54) in response to a sensed phase-controlled power signal (52), and a micro-processor (56) responsive to the on-time signal (54) and generating a dimming control signal (58). A lamp control method for an electronic ballast includes sensing phase-controlled power, determining on-time for the sensed phase-controlled power, and controlling lamp dimming in response to the on-time.

This invention relates generally to lamp dimming control, and more specifically to a method and system for lamp dimming with universal line voltages.

Electronic ballasts for fluorescent lamps have become sophisticated and are widely used in a variety of applications. One application that has presented problems is dimmable electronic ballasts. Modern dimming switches, such as triac dimmers, generate a phase-controlled power with reduced on-time, i.e., the time in which the chopped phase-controlled power is non-zero. The line input power briefly crosses zero power between positive and negative, but the phase-controlled power holds the zero power longer to limit power to a load. Triac dimmers work well for resistive loads, such as incandescent lamps, but work poorly or not at all for non-linear loads, such as ballasts for fluorescent lamps. Non-linear loads can hum, buzz, run hot, or burn out.

Dimmable electronic ballasts have been designed to work with triac dimmers, but such dimmable electronic ballasts are limited to use with a predetermined line input voltage, e.g., a dimmable electronic ballast for triac dimmers designed to operate at 120 Volts cannot be used with a 277 Volt line input voltage. The dimming control voltage signal is generated within the dimmable electronic ballast, so the voltage of the dimming control voltage signal is affected by the line input voltage to the dimmable electronic ballast. Attempting to use present dimmable electronic ballast for triac dimmers at a voltage other than the predetermined line input voltage gives rise to problems with power factor, total harmonic distortion, and stability. The requirement that different dimmable electronic ballasts be used for different predetermined line input voltages causes additional expense in manufacturing and stocking different dimmable electronic ballasts for different line input voltages.

It would be desirable to provide a universal line voltage dimming method and system that overcomes the above disadvantages.

One aspect of the invention provides a control circuit for an electronic ballast including an on-time converter generating an on-time signal in response to a sensed phase-controlled power signal, and a microprocessor responsive to the on-time signal and generating a dimming control signal.

Another aspect of the invention provides a lamp control method for an electronic ballast including sensing phase-controlled power, determining on-time for the sensed phase-controlled power, and controlling lamp dimming in response to the on-time.

Another aspect of the invention provides a lamp control system including means for sensing phase-controlled power, means for determining on-time for the sensed phase-controlled power, and means for controlling lamp dimming in response to the on-time.

Another aspect of the invention provides control circuit for an electronic ballast having a boost/power factor controller including a line voltage detector generating a line voltage signal in response to a sensed phase-controlled power signal, a microprocessor responsive to the line voltage signal and generating a capacitance selector signal, and a capacitance circuit responsive to the capacitance selector signal to adjust capacitance of the boost/power factor controller.

Another aspect of the invention provides a lamp control method for an electronic ballast including sensing a phase-controlled power, determining line voltage for the sensed phase-controlled power, and adjusting boost/power factor controller capacitance in response to the line voltage.

Another aspect of the invention provides a lamp control system including means for sensing a phase-controlled power, means for determining line voltage for the sensed phase-controlled power, and means for adjusting boost/power factor controller capacitance in response to the line voltage.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

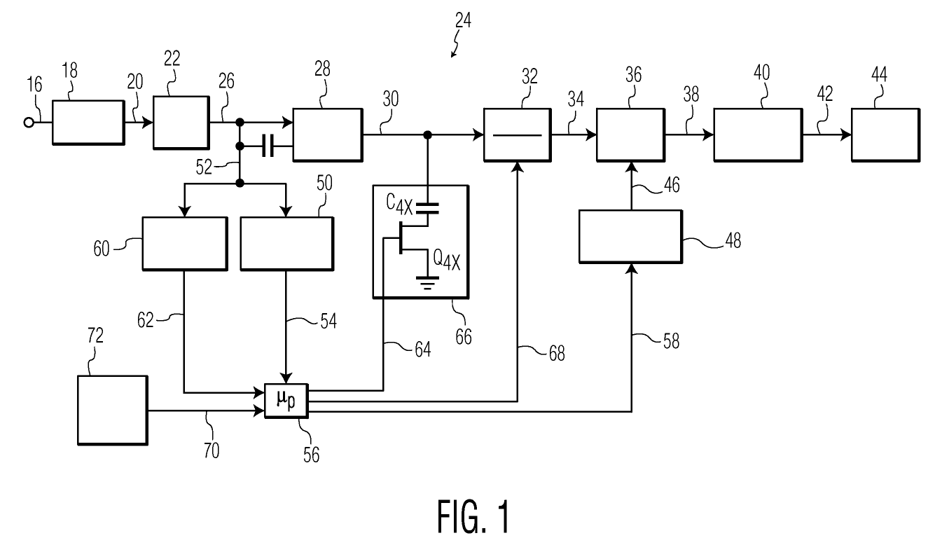

FIG. 1 is a block diagram of a lighting system with a universal dimming electronic ballast made in accordance with the present invention;

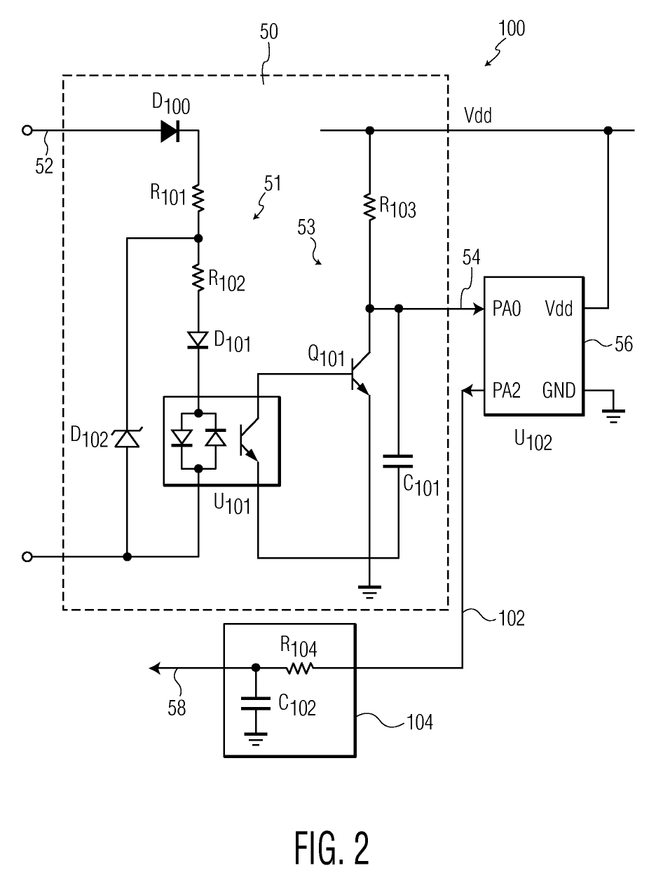

FIGS. 2 & 3 are a schematic diagram and voltage traces, respectively, for a dimming circuit for a universal dimming electronic ballast made in accordance with the present invention; and

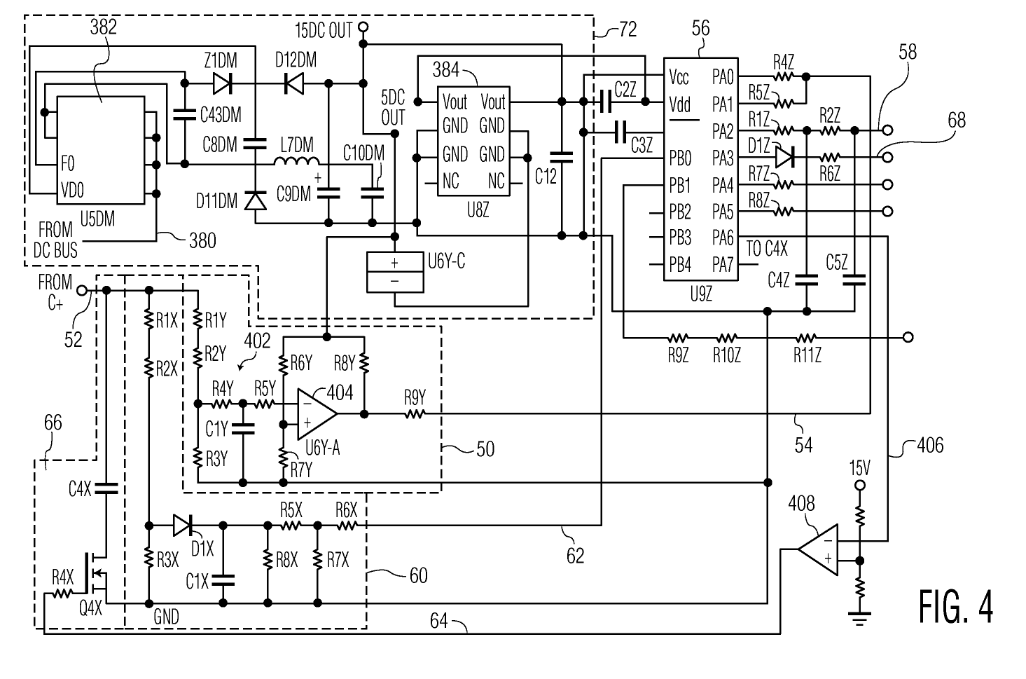

FIG. 4 is a schematic diagram of dimming, capacitance selection, and stability circuits for a universal dimming electronic ballast made in accordance with the present invention.

FIG. 1 is a block diagram of a lighting system with a universal dimming electronic ballast made in accordance with the present invention. The electronic ballast adapts to any phase-controlled power provided by a dimmer to produce the lamp dimming desired. The wave form of the power to the lamp is unaffected by the line voltage. An on-time converter converts the phase-controlled power to an on-time, which is converted to a dimming control signal. A line voltage detector detects line voltage and adjusts boost circuit capacitance through a capacitance selection circuit and/or adjusts the power factor controller internal multiplier through a stability circuit to maintain electronic ballast operating stability. Those skilled in the art will appreciate that the phase-controlled power can be supplied by any phase-control device, such as a triac dimmer or the like.

Electronic ballast 24 receives phase-controlled power 20 from dimmer 18 at EMI filter 22 and provides lamp power 42 for a lamp 44 from resonant tank 40. The dimmer 18 receives mains power 16, such as 120 Volt or 277 Volt power line power, and controls the phase of the mains power 16 to reduce the power provided to the electronic ballast 24 and dim the lamp 44. The exemplary electronic ballast 24 includes the EMI filter 22 operably connected to the dimmer 18 and a DC rectifier 28, which provides rectified power 30 to boost/power factor controller (PFC) 32. The boost/PFC 32 provides DC bus power 34 to switching circuit 36, which provides switched power 38 to resonant tank 40. The switching circuit 36 is responsive to switching control signal 46 from a switching controller 48. The resonant tank 40 provides lamp power 42 to the lamp 44.

The electronic ballast 24 can include a dimming circuit with an on-time converter 50 receiving a sensed phase-controlled power signal 52 and generating an on-time signal 54. A microprocessor 56 in the dimming circuit is responsive to the on-time signal 54 to generate a dimming control signal 58, which is provided to the switching controller 48. The dimming circuit senses the phase-controlled power, calculates on-time for the sensed phase-controlled power, and controls lamp dimming in response to the on-time. As defined herein, on-time is the duration for which each positive or negative voltage pulse of the sensed phase-controlled power signal 52 is non-zero. Those skilled in the art will appreciate that in alternate embodiments the microprocessor 56 can be conventional circuits, rather than an integrated circuit programmable microprocessor; the functions of the microprocessor 56 can be performed by conventional circuits rather than the programmable microprocessor as desired. The microprocessor 56 receives DC power 70 from a DC power supply 72. The DC power supply 72 can be powered from any suitable location within the electronic ballast 24, such as the DC bus.

The electronic ballast 24 can include a capacitance selection circuit with a line voltage detector 60 receiving the sensed phase-controlled power signal 52 and generating a line voltage signal 62. The microprocessor 56 is responsive to the line voltage signal 62 to generate a capacitance selector signal 64, which is provided to capacitance circuit 66. The capacitance circuit 66 is operably connected to adjust the capacitance to the boost/PFC 32. The capacitance selection circuit implements a lamp control method that senses a phase-controlled power, determines line voltage for the sensed phase-controlled power, and adjusts boost/PFC capacitance in response to the line voltage.

The electronic ballast 24 can include a stability circuit with the line voltage detector 60 receiving the sensed phase-controlled power signal 52 and generating the line voltage signal 62. The microprocessor 56 is responsive to the line voltage signal 62 to generate an internal multiplier signal 68, which is provided to the boost/PFC 32. The stability circuit implements a lamp control method that senses a phase-controlled power, determines line voltage for the sensed phase-controlled power, and selects a boost/PFC internal multiplier in response to the line voltage.

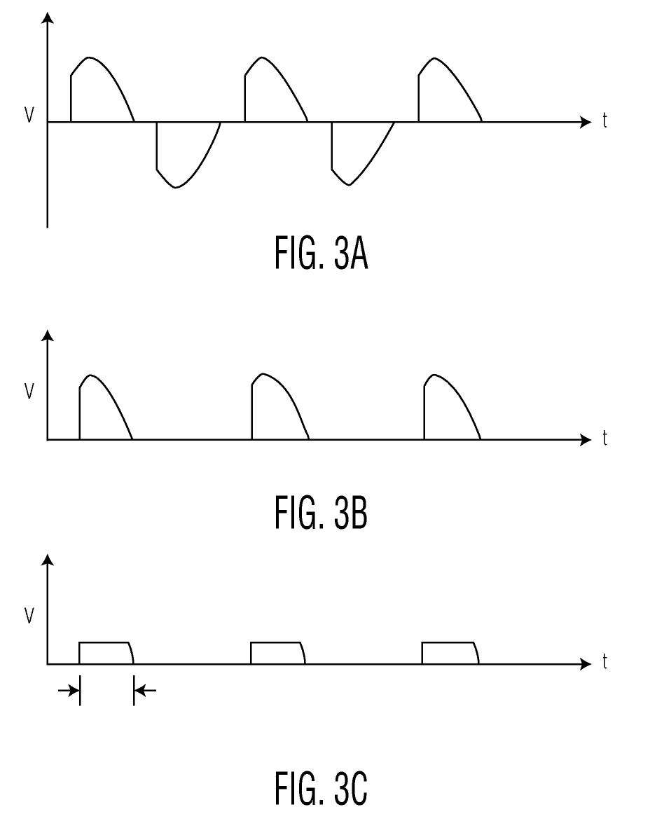

FIG. 2, in which like elements share like reference numbers with FIG. 1, is a schematic diagram of a dimming circuit for a universal line voltage dimming circuit made in accordance with the present invention. FIG. 3 illustrates voltage traces for the dimming circuit of FIG. 2. Referring to FIG. 2, dimming circuit 100 includes on-time converter 50 and microprocessor 56. The on-time converter 50 receives sensed phase-controlled power signal 52 and generates on-time signal 54. The microprocessor 56 receives the on-time signal 54 and generates pulsed dimming control signal 102, which is converted to the smoothed dimming control signal 58 by filter 104.

The on-time converter 50 includes rectifier D100 operably connected to a clipping circuit 51 and a switching circuit 53 operably connected to the clipping circuit 51 through an isolator U101. The clipping circuit 51 includes voltage divider resistors R101 and R102, Zener diode D102 connected between common and the junction of resistors R101 and R102, and optional diode D101. The diode D101 can be omitted when the current through the isolator U101 only flows in one direction, i.e., the isolator U101 receives a DC input. The on-time converter 50 also includes the isolation path diode side of isolator U101 operably connected in series with the diode D101 and the isolation path phototransistor side of isolator U101 operably connected between common and the base of switching transistor Q101. The isolator U101 in this example is an AC sensing phototransistor output optocoupler, although a DC sensing phototransistor output optocoupler can be used in this embodiment because the current through the isolator U101 only flows in one direction. The isolator U101 can be any suitable isolator, such as an optocoupler, an isolation transformer, or the like. The switching circuit 53 includes resistor R103 and capacitor C101 connected in series between Vdd and common, switching transistor Q101 with the collector-emitter path connected in parallel to the capacitor C101, and isolator U101 with the isolation path phototransistor side connected between the base of the switching transistor Q101 and common. The collector of the switching transistor Q101 is connected to terminal PA0 of the microprocessor 56 to provide the on-time signal 54 to the microprocessor 56.

In operation, the on-time converter 50 receives the phase-controlled power signal 52, which is shown in Trace A of FIG. 3. The phase-controlled power signal 52 is phase-controlled, i.e., the voltage is held at zero for a portion of the cycle to reduce power to the lamp and dim the lamp. The rectifier D100 rectifies the phase-controlled power signal 52, resulting in the rectified phase-controlled power shown in Trace B of FIG. 3, corresponding to the rectified phase-controlled power at the location between the rectifier D100 and the resistor R101. In an alternative embodiment, the rectifier can be a full wave rectifier rather than the half wave rectifier D100. The clipping circuit conducts through diode D101 until the voltage at the junction of resistors R101 and R102 exceeds the reverse breakdown voltage of the Zener diode D102, so that the Zener diode D102 then conducts as well and limits the voltage at the junction of resistors R101 and R102. Trace C of FIG. 3 illustrates the voltage of the on-time pulses at the junction of resistors R101 and R102. The on-time is the time between the leading and the lagging edge of each on-time pulse. The on-time pulses switch the current through the diode of the isolator U101, which switches the state of the phototransistor of the isolator U101 and the switching transistor Q101, in turn. The switching transistor Q101 switches voltage from resistor R103 across capacitor C101 to generate the on-time signal 54 at the junction between the resistor R103 and capacitor C101.

The microprocessor 56 analyzes the on-time signal 54 for the on-time and generates the pulsed dimming control signal 102 in accordance with instructions and data stored in the microprocessor 56. The microprocessor 56 detects when the on-time signal 54 goes above a predetermined level, such as 2.5 Volts, to start timing the on-time and when the on-time signal 54 goes below the predetermined level to finish timing the on-time. In an alternate embodiment, the on-time is determined from the slope change of the on-time signal 54 at the leading edge and the lagging edge of the on-time pulse. Those skilled in the art will appreciate that the on-time signal 54 can be inverted as desired, so that the timing the on-time starts and ends when the on-time signal 54 passes beyond the predetermined level, not necessarily exceeding or falling below the predetermined level.

The on-time is converted to the pulsed dimming control signal 102 by calculation or look up table in the microprocessor 56. In one embodiment, the on-time is determined for a single on-time pulse from the on-time signal 54. In an alternate embodiment, the on-time is a moving average on-time determined for a predetermined number of on-time pulses from the on-time signal 54, such as 2, 3, 4, 8, or 16 on-time pulses. In another alternate embodiment, the on-time is a time-weighted average, such as an average assigning greater statistical weight to the more recent on-time pulses. In one embodiment, the conversion from the on-time to the pulsed dimming control signal 102 is a linear function. In an alternate embodiment, the conversion from the on-time to the pulsed dimming control signal 102 is a non-linear function. For example, the conversion can be a logarithmic function to account for the fact that human eyes perceive a higher light level for a dimmed light than the actual light level that would be recorded by a light meter. In one embodiment, the span and offset of the conversion can be selected, e.g., an on-time of about 8.3 milliseconds converts to a full on pulsed dimming control signal 102, an on-time of about 4 milliseconds converts to a middle pulsed dimming control signal 102, and an on-time of about 2.8 milliseconds converts to a minimum pulsed dimming control signal 102.

The microprocessor 56 generates the pulsed dimming control signal 102, which is converted to the smoothed dimming control signal 58 by the filter 104. The filter 104 includes resistor R104 and capacitor C102. The span and offset of the smoothed dimming control signal 58 can be selected for the desired application, such as about 0.3 to 2.8 Volts corresponding to minimum light output (maximum dimming) and full on light output, respectively. In an alternate embodiment, the microprocessor 56 generates an analog signal as the dimming control signal 58 and the filter 104 can be omitted. A control microprocessor in the switching controller receives the smoothed dimming control signal 58 and provides the switching control signal to the switching circuit to set the desired lamp dimming level. In an alternate embodiment, the microprocessor 56 generates a pulsed signal as the dimming control signal 58 and the control microprocessor in the switching controller is responsive to the pulsed signal.

FIG. 4, in which like elements share like reference numbers with FIG. 1, is a schematic diagram of dimming, capacitance selection, and stability circuits for a universal dimming electronic ballast made in accordance with the present invention. The dimming circuit converts the sensed phase-controlled power signal to a dimming control signal, the capacitance selection circuit detects the line voltage and switches capacitance at the boost/PFC, and the stability circuit detects the line voltage and provides that information to the boost/PFC. DC power supply 72 receives DC bus power 380 and powers the microprocessor circuit, capacitance selection circuit, stability circuit, and other components as desired. The DC power supply 72 includes 15V power supply 382 and 5V power supply 384.

The dimming circuit includes the on-time converter 50 and the microprocessor 56. The on-time converter 50 receives the sensed phase-controlled power signal 52 and generates the on-time signal 54. The microprocessor 56 receives the on-time signal 54 and generates dimming control signal 58. The on-time converter 50 includes scaling circuit 402 and comparator 404. The scaling circuit 402 scales and smoothes the sensed phase-controlled power signal 52, which is compared to a predetermined voltage at the comparator 404 to generate the dimming control signal 58. The processing of the dimming control signal 58 to generate the switching control signal 46 is discussed above in conjunction with FIGS. 2 & 3.

The capacitance selection circuit includes the line voltage detector 60, microprocessor 56, and capacitance circuit 66. The line voltage detector 60 detects the voltage of the main power feeding the dimmer. In this example, the line voltage detector 60 is a line peak detector which provides a line voltage signal 62 proportional to the peak voltage of the sensed phase-controlled power signal 52. The microprocessor 56 detects the level of the line voltage signal 62 and determines whether the main power is high voltage, such as 277 Volts, or a lower voltage, such as 120 Volts. In this example, the microprocessor 56 generates an inverted capacitance selector signal 406, which is inverted at inverter 408 to generate the capacitance selector signal 64. When the main power is high voltage, the microprocessor 56 sets the inverted capacitance selector signal 406 to a first level and when the main power is not high voltage, the microprocessor 56 sets the inverted capacitance selector signal 406 to a second level. When the main power is high voltage as indicated by the capacitance selector signal 64, transistor Q4X in the capacitance circuit 66 is off and no extra capacitance is added to the boost/PFC. When the main power is not high voltage as indicated by the capacitance selector signal 64, transistor Q4X in the capacitance circuit 66 is on and extra capacitor C4X is added to the boost/PFC. Decreasing capacitance increases stability at the higher main power voltage. Using different capacitance values also improves power factor and total harmonic distortion at the different main power voltages.

The stability circuit includes the line voltage detector 60 and microprocessor 56. As discussed above for the capacitance selection circuit, the line voltage detector 60 receives the sensed phase-controlled power signal 52 and generates the line voltage signal 62 at the microprocessor 56. The microprocessor 56 detects the level of the line voltage signal 62 and determines whether the main power is high voltage, such as 277 Volts, or a lower voltage, such as 120 Volts. When the main power is high voltage, the microprocessor 56 sets the internal multiplier signal 68 to a first level and when the main power is not high voltage, the microprocessor 56 sets the internal multiplier signal 68 to a second level. The internal multiplier signal 68 is provided to the boost/PFC, such as the MULTIN pin of a PFC integrated circuit in the boost/PFC. When the main power is high voltage as indicated by the internal multiplier signal 68, the MULTIN pin of a PFC integrated circuit is held at a first level. When the main power is not high voltage as indicated by the internal multiplier signal 68, the MULTIN pin of a PFC integrated circuit is held at a second level. For example, in one embodiment the first level is low and the second level is high. Those skilled in the art will appreciate that the effect of feeding a small current to the MULTIN pin voltage to increase stability of the PFC integrated circuit depends on the particular electronic ballast design, so that whether the MULTIN pin is held high or low for high voltage depends on the particular electronic ballast design.

While the embodiments of the invention disclosed herein are presently considered to be preferred, various changes and modifications can be made without departing from the scope of the invention. Those skilled in the art will appreciate that the embodiments described for FIGS. 1, 2, & 4 are exemplary and that alternative circuits can be used as desired for particular applications. The scope of the invention is indicated in the appended claims, and all changes that come within the meaning and range of equivalents are intended to be embraced therein.

1. A control circuit for an electronic ballast comprising:
an on-time converter 50, the on-time converter 50 generating an on-time signal 54 in response to a sensed phase-controlled power signal 52; and
a microprocessor 56, the microprocessor 56 being responsive to the on-time signal 54 and generating a dimming control signal 58.

2. The circuit of claim 1 wherein the on-time converter 50 comprises:
a rectifier D100 operably connected to receive the sensed phase-controlled power signal 52;
a clipping circuit 51 operably connected to the rectifier D100; and
a switching circuit 53 operably connected to the clipping circuit 51 through an isolator U101, the switching circuit 53 being operably connected to transmit the on-time signal 54.

3. The circuit of claim 2 wherein the isolator U101 is selected form the group consisting of optocouplers and isolation transformers.

4. The circuit of claim 2 wherein the clipping circuit 51 comprises:
a voltage divider having a first resistor R101 and a second resistor R102 connected in series;
a first isolation path of the isolator U101, the first isolation path connected in series with the second resistor R102; and
a Zener diode D102;
wherein the Zener diode D102 is connected in parallel with the second resistor R102 and the first isolation path.

5. The circuit of claim 2 wherein the rectifier D100 is a half wave rectifier.

6. The circuit of claim 1 further comprising a filter 104 operably connected to receive a pulsed dimming control signal 102 from the microprocessor 56 and to generate the dimming control signal 58.

7. The circuit of claim 1 wherein the on-time converter 50 comprises:
a scaling circuit 402 operably connected to receive the sensed phase-controlled power signal 52; and
a comparator 404 operably connected to the scaling circuit 402, the comparator 404 transmitting the on-time signal 54.

8. The circuit of claim 1 wherein the dimming control signal 58 is a linear function of the on-time signal 54.

9. The circuit of claim 1 wherein the dimming control signal 58 is a function of the on-time signal 54 selected from the group consisting of non-linear functions and logarithmic functions.

10. The circuit of claim 1 further comprising:
a line voltage detector 60, the line voltage detector 60 generating a line voltage signal 62 in response to the sensed phase-controlled power signal 52; and
a capacitance circuit 66, the capacitance circuit 66 being responsive to a capacitance selector signal 64 to adjust capacitance of a boost/power factor controller 32;
wherein the microprocessor 56 is responsive to the line voltage signal 62 and generates the capacitance selector signal 64.

11. The circuit of claim 10 wherein the microprocessor 56 is responsive to the line voltage signal 62 to generate an internal multiplier signal 68 to adjust an internal multiplier of the boost/power factor controller 32.

12. A lamp control method for an electronic ballast comprising:
sensing phase-controlled power;
determining on-time for the sensed phase-controlled power; and
controlling lamp dimming in response to the on-time.

13. The method of claim 12 wherein the determining comprises:
rectifying the sensed phase-controlled power to generate rectified phase-controlled power;
clipping the rectified phase-controlled power to generate an on-time pulse;
measuring duration of the on-time pulse to determine the on-time.

14. The method of claim 13 wherein the measuring comprises measuring time when the on-time pulse is beyond a predetermined level.

15. The method of claim 13 wherein the measuring comprises measuring time between the leading edge and the lagging edge of the on-time pulse.

16. The method of claim 12 wherein the determining comprises:
rectifying the phase-controlled power to generate rectified phase-controlled power;
clipping the rectified phase-controlled power to generate a series of on-time pulses;
measuring duration for each of the series of on-times pulses; and
averaging the durations to determine the on-time.

17. The method of claim 16 wherein the averaging is selected from the group consisting of moving averaging and time-weighted averaging.

18. The method of claim 12 wherein the determining comprises:
scaling the phase-controlled power to generate scaled phase-controlled power; and
comparing the scaled phase-controlled power to a predetermined level to determine the on-time.

19. The method of claim 12 wherein the controlling comprises controlling lamp dimming to account for human perception of light level.

20. The method of claim 12 further comprising:
determining line voltage for the sensed phase-controlled power; and
adjusting boost/power factor controller capacitance in response to the line voltage.

21. The method of claim 20 further comprising selecting a boost/power factor controller internal multiplier in response to the line voltage.

22. A lamp control system comprising:
means for sensing phase-controlled power;
means for determining on-time for the sensed phase-controlled power; and
means for controlling lamp dimming in response to the on-time.

23. The system of claim 22 wherein the means for determining comprises:
means for rectifying the sensed phase-controlled power to generate rectified phase-controlled power;
means for clipping the rectified phase-controlled power to generate an on-time pulse;
means for measuring duration of the on-time pulse to determine the on-time.

24. The system of claim 23 wherein the means for measuring comprises means for measuring time when the on-time pulse is beyond a predetermined level.

25. The system of claim 22 wherein the determining comprises:
means for rectifying the sensed phase-controlled power to generate rectified phase-controlled power;
means for clipping the rectified phase-controlled power to generate a series of on-time pulses;
means for measuring duration for each of the series of on-times pulses; and
means for averaging the durations to determine the on-time.

26. The system of claim 25 wherein the means for averaging comprises means for moving averaging.

27. The system of claim 22 wherein the means for determining comprises:
means for scaling the phase-controlled power to generate scaled phase-controlled power; and
means for comparing the scaled phase-controlled power to a predetermined level to determine the on-time.

28. The system of claim 22 wherein the means for controlling comprises means for controlling lamp dimming to account for human perception of light level.

29. The system of claim 22 further comprising:
means for determining line voltage for the sensed phase-controlled power; and
means for adjusting boost/power factor controller capacitance in response to the line voltage.

30. The system of claim 29 further comprising means for selecting a boost/power factor controller internal multiplier in response to the line voltage.

31. A control circuit for an electronic ballast having a boost/power factor controller comprising:
a line voltage detector 60, the line voltage detector 60 generating a line voltage signal 62 in response to a sensed phase-controlled power signal 52;
a microprocessor 56, the microprocessor 56 being responsive to the line voltage signal 62 and generating a capacitance selector signal 64; and
a capacitance circuit 66, the capacitance circuit 66 being responsive to the capacitance selector signal 64 to adjust capacitance of the boost/power factor controller 32.

32. The circuit of claim 31 wherein the line voltage detector 60 is a line peak detector.

33. The circuit of claim 31 wherein the microprocessor 56 is further responsive to the line voltage signal 62 to generate an internal multiplier signal 68 to adjust an internal multiplier of the boost/power factor controller 32.

34. The circuit of claim 31 further comprising:
an on-time converter 50, the on-time converter 50 generating an on-time signal 54 in response to the sensed phase-controlled power signal 52;
wherein the microprocessor 56 is responsive to the on-time signal 54 to generate a dimming control signal 58.

35. A lamp control method for an electronic ballast comprising:
sensing a phase-controlled power;
determining line voltage for the sensed phase-controlled power; and
adjusting boost/power factor controller capacitance in response to the line voltage.

36. The method of claim 35 wherein the determining comprises determining line voltage from peak voltage of the sensed phase-controlled power.

37. The method of claim 35 further comprising selecting a boost/power factor controller internal multiplier in response to the line voltage.

38. The method of claim 35 further comprising:
determining on-time for the sensed phase-controlled power; and
controlling lamp dimming in response to the on-time.

39. A lamp control system for an electronic ballast comprising:
means for sensing a phase-controlled power;
means for determining line voltage for the sensed phase-controlled power; and
means for adjusting boost/power factor controller capacitance in response to the line voltage.

40. The system of claim 39 wherein the means for determining comprises means for determining line voltage from peak voltage of the sensed phase-controlled power.

41. The system of claim 39 further comprising means for selecting a boost/power factor controller internal multiplier in response to the line voltage.

42. The system of claim 39 further comprising:
means for determining on-time for the sensed phase-controlled power; and
means for controlling lamp dimming in response to the on-time.
